(19) United States
(12) Patent Application Publication
(10) Pub. No.: US 2017/0347626 A1
(43) Pub. Date: Dec. 7, 2017

(54) PET WATER FEED WITH WATER LEVEL ALARM FUNCTION

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/171,529

(22) Filed: Jun. 2, 2016

(51) Int. Cl. A01K 7/02; G08B 21/18

(52) U.S. Cl. CPC A01K 7/02; G08B 21/182

(57) ABSTRACT

A pet water feeder with a water level alarm function, comprising a water storage tank and a water drinking basin, which are configured to be in fluid communication with each other, wherein a water level sensor is installed inside the water drinking basin close to a bottom of the water drinking basin, and a buzzer is installed on the bottom outside the water drinking basin.

### TECHNICAL FIELD

The invention relates to a water feeder, and more particularly, to a pet water feed with water level alarm function.

### BACKGROUND ART

Raising pets is very universal and common in the present society, and has become a very important way of enjoyment for people. People and pets have established an important relationship, and the intimating degree of this relationship may even beyond family affection, friendship and love sometimes because the relationship between the two is very simple but subtle. The pets as partner animals of we human beings is one resource for we human beings to gain happy and healthy life, and raising pets may make the life of people healthier and more fulfilling.

Presently, the master takes good care of the pet raised thereby, and even considers the pet as a family member or a child thereof, so to speak that the master keeps all kinds in stock for the pet. But the pet is not allowed to enter may occasions because it is still a pet after all; moreover, the master may not accompany it around all the time. In order to prevent the pet from feeling thirsty, the master may usually fill full of water in a water feeder, and put the water feeder in a corner indoors; but the master will also possibly forget to add water in the water feeder over time.

### SUMMARY OF THE INVENTION

An object of the invention is to provide pet water feeders with water level alarm functions to alleviate or minimize all or some of the foregoing problems. Embodiments of the invention can automatically remind the master to add water when the water levels in the water feeders are lower than a set point.

An object of the invention may be implemented as follows.

A pet water feeder with a water level alarm function includes a water storage tank and a water drinking basin (water bowl), which are in fluid communication with each other, wherein a water level sensor is installed inside the water drinking basin close to the bottom of the water drinking basin. A buzzer is installed on the water feeder, e.g., outside the water drinking basin.

In some embodiments, the water storage tank may be detachably installed on the water drinking basin.

In some embodiments, the water drinking basin may be provided with a connecting portion. The connecting portion may be provided with a sunken round recess platform, and the center of the round recess platform is in communication with the bottom of the water drinking basin. A connecting pipe matched with an water outlet of the water storage tank may be vertically extended upwards along the center of the round recess platform.

In some embodiments, the inner wall of the connecting pipe and the water outlet of the water storage tank are respectively provided with an internal thread and an external thread which are matched with each other.

In some embodiments, the bottom of the round recess platform is located at a height ranging from one half to two thirds of the water drinking basin.

In some embodiments, the bottom of the connecting portion is provided with a battery box which can be downwards opened.

The invention may have one or more of the following advantageous effects: when the water level in the water drinking basin of the water feeder is lower than the water level sensor, the buzzer may sound to remind the master (pet owner) to add water.

### BRIEF DESCRIPTION OF THE DRAWINGS

FIG. 1 is a block diagram of one embodiment of the invention.

FIG. 2 is a cross-sectional view of one embodiment of the invention.

### DETAILED DESCRIPTION

Embodiments of the invention will be further described in details hereinafter with reference to the drawings and specific examples.

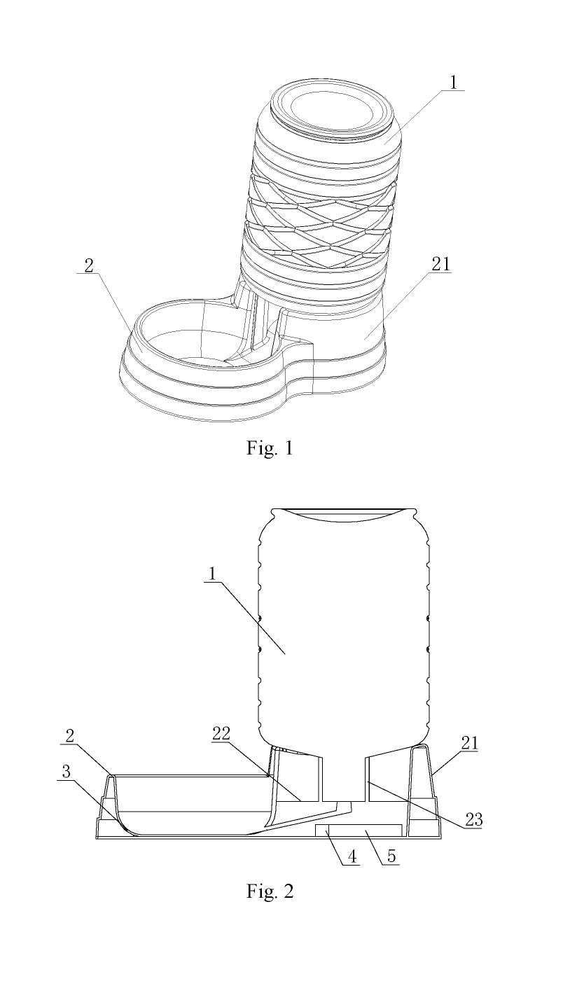

As shown in FIG. 1, a pet water feeder with a water level alarm function includes a water storage tank 1 and a water drinking basin 2, which are configured to be in fluid communication with each other, wherein a water level sensor 3 is installed inside the water drinking basin 2 close to the bottom of the water drinking basin 2. A buzzer 4 is installed on the bottom outside the water drinking basin 2.

To add water conveniently, the water storage tank 1 is detachably installed on the water drinking basin 2. The connection may be as follows: the water drinking basin 2 is provided with a connecting portion 21. The connecting portion 21 is provided with a sunken round recess platform 22. The center of the round recess platform 22 is provided with a through hole configured to be in communication with the water drinking basin 2. A connecting pipe 23 matching an water outlet of the water storage tank 1 extends vertically upwards along the center of the round recess platform 22. The connecting pipe 23 may be connected with the water outlet of the water storage tank 1 through the matched internal thread and external thread.

In some embodiments, the inner diameter of the connecting pipe and the internal diameter can be designed into a universal type, and configured to match an universal opening of a conventional bottle (e.g., a coke bottle or other beverage bottle). In this way, the water storage tank 1 can be directly replaced by a coke bottle or other beverage bottle, thereby achieving the object of recycling waste beverage bottle.

In order to prevent overflow caused by the unceasing flowing of the water in the water storage tank 1 towards the water drinking basin 2, the bottom of the round recess platform 22 is designed to be located at a height ranging from one half to two thirds of height of the water drinking basin 2, so that when the water level in the water drinking basin 2 is equal to the height of the bottom of the round recess platform 22, the water in the water storage tank 1 will stop flowing towards the water storage tank 2.

To install a battery conveniently, the bottom of the connecting portion 21 may be provided with a battery box 5, which, for example, may be opened downwards.

When an embodiment of the invention is in use, the buzzer 4 may be triggered to sound when the water in the water storage tank 1 is used up and the water level in the water drinking basin 2 is lower than the water level sensor 3, thereby reminding the master (pet owner) to add water in time. When adding water, one only needs to unscrew the water storage tank 1, fill it with water, and then re-install the water storage tank on the water drinking basin 2.

What is claimed is:

1. A pet water feeder with a water level alarm function, comprising a water storage tank and a water drinking basin, which are configured to be in fluid communication with each other, wherein a water level sensor is installed inside the water drinking basin close to a bottom of the water drinking basin, and a buzzer is installed on the bottom outside the water drinking basin.

2. The pet water feeder with a water level alarm function according to claim 1, wherein the water storage tank is detachably installed on the water drinking basin.

3. The pet water feeder with a water level alarm function according to claim 2, wherein the water drinking basin is provided with a connecting portion, wherein the connecting portion is provided with a sunken round recess platform, the center of which is configured to be in fluid communication with the bottom of the water drinking basin, and a connecting pipe matching an water outlet of the water storage tank extends vertically upwards along a center of the round recess platform.

4. The pet water feeder with a water level alarm function according to claim 3, wherein an inner wall of the connecting pipe and the water outlet of the water storage tank are respectively provided with an internal thread and an external thread, which are configured to mate with each other.

5. The pet water feeder with a water level alarm function according to claim 3, wherein the bottom of the round recess platform is located at a height ranging from one half to two thirds of a depth of the water drinking basin.

6. The pet water feeder with a water level alarm function according to claim 1, wherein the bottom of the connecting portion is provided with a battery box, which can be opened downwardly.
